(19) United States
(12) Patent Application Publication
(10) Pub. No.: US 2008/0152452 A1
(43) Pub. Date: Jun. 26, 2008

(54) Clamp for truck racks

(76) Inventor: Christopher Phillip Green, Madera, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/644,274

(22) Filed: Dec. 22, 2006

(51) Int. Cl. B60P 3/06

(52) U.S. Cl. 410/3

(57) ABSTRACT

A clamp for securing the base member of a truck rack to the bedrail of a pickup truck is easy to install and remove without requiring drilling holes or other modifications to the pickup truck. The clamp comprises a lower clamp assembly, an upper clamp assembly and an engaging mechanism configured to join the two assemblies together and clamp the base member to the bedrail. The lower clamp assembly has a platform member with an engaging member and a spaced apart insert member upwardly disposed thereon. The upper clamp assembly has a clamp member with an attached or integral channel member that defines an insert channel configured to slidably receive the insert member. The engaging mechanism, preferably a screw or like connector, connects to the insert member to clamp the base member between the clamp member and the bedrail while the engaging member abuts the underside of the bedrail.

### CROSS-REFERENCE TO RELATED APPLICATIONS

This patent application claims the benefit of U.S. patent application Ser. No. 10/607,964 filed Jun. 27, 2003.

### BACKGROUND OF THE INVENTION

A. Field of the Invention

The field of the present invention relates generally to clamping systems utilized to secure truck racks to pickup trucks and similar vehicles. More particularly, the present invention relates to clamps that removably secure a truck rack to the bedrail of pickup truck. Even more particularly, the present invention relates to such clamps that are easily and quickly installed without requiring the user to drill holes into the truck.

B. Background

Many people ride motorcycles as their main form of transportation or for recreation or competitive purposes, including off-road enjoyment and racing. Many of the motorcycles that are driven primarily for off-road recreation or racing are not licensed for use on highways or, even if licensed or licensable for highway use, are not used for long distance highway travel. Most recreation areas that are particularly enjoyable and suitable for off-road motorcycle riding, including relatively large open areas such as forests and deserts, are typically located somewhat remote from cities and towns. It is also well known that motorcycle racing tracks, whether for professional or amateur racing, are generally not located in large population centers, due in part to local zoning regulations prohibiting such tracks. As such, the use of motorcycles for off-road recreation or racing purposes generally requires the transport of the motorcycle from the owner's house or other location where the motorcycle is stored to the typically distant recreation area or race track. It is also occasionally necessary or perhaps desirable to transport motorcycles that are licensed and suitable for driving on the highway instead of riding the motorcycle. For instance, the owner may need to transport the motorcycle to a repair facility or he or she may desire to transport the motorcycle to location to be used as a starting point for a motorcycle trip.

The typical motorcycle owner either utilizes a separate trailer, which is configured to haul one or more motorcycles, hitched to the back of another vehicle or place the motorcycle(s) in the back of a truck, such as the bed of a pickup truck. While specifically configured motorcycle trailers have certain advantages with regard to hauling motorcycles, relative to pickup truck beds and flat trailers (both of which are adaptable to a variety of non-motorcycle hauling uses), the use of a separate motorcycle trailer is not favored by many motorcycle owners due to the cost of the trailer, need for storage during non-use and its limited adaptability for hauling other materials and equipment. As a result, use of a pickup truck or flat trailer to haul a motorcycle is perhaps the most popular means of transporting motorcycles from one location to another. Once placed on the pickup truck or trailer bed, the motorcycle is typically strapped into position using ropes, stretch cords or other devices configured to prevent the motorcycle from falling over during transport. As is well known, failure to properly secure the motorcycle to the pickup truck or trailer bed can result in substantial damage, including total loss, to the motorcycle and damage to the pickup truck or trailer. In more severe cases, an improperly secured motorcycle can even result in damage to vehicles traveling behind the pickup or trailer carrying the motorcycle and/or injury or death to persons in those vehicles.

A number of prior art patents describe devices which can be used with a pickup truck, trailer or other vehicle to transport a motorcycle. Certain of these devices are configured to carry the motorcycle at the back end of the vehicle. For instance U.S. Pat. No. 4,084,736 to Jacobs, Jr. describes a vehicle mounted motorcycle rack that mounts to the back end of a vehicle and which is configured to raise the motorcycle to a fixed position for transport. U.S. Pat. No. 3,931,903 to Johnson describes a motorcycle rack for vehicles that operates in a similar fashion to transport a motorcycle at the back end of a vehicle slightly above the ground level. U.S. Pat. No. 4,034,872 to Jager describes a motorcycle rack for a tow truck that is adapted to be mounted on a tow truck sling and carry the motorcycle behind the tow truck. None of the aforementioned patents are configured to safely and securely retain one or more motorcycles in the bed of a pickup truck or on a trailer bed. Numerous patents describe racks configured to carry one or more bicycles in the bed of a pickup truck. One configuration, exemplified by U.S. Pat. No. 5,836,490 to Price, mounts to the side walls of the pickup bed compartment to receive the front and back wheels of the bicycle. U.S. Pat. No. 5,427,286 to Hagerty and U.S. Pat. No. 5,127,564 to Romero exemplify configurations where the mounting assembly mounts to the front of the pickup truck bed to attach to the bicycle handlebars. In another configuration, exemplified by U.S. Pat. No. 5,611,472 to Miller, U.S. Pat. No. 5,516,020 to Lawler et al. and U.S. Pat. No. 5,014,890 to Perry, the rack mounts at or near the center of the pickup bed so that it can grasp a tube portion of the bicycle frame. In yet another configuration, exemplified by U.S. Pat. No. 6,398,091 to Munoz et al. and U.S. Pat. No. 5,092,504 to Hannes et al., the bicycle racks attaches to the frame of the bicycle with the front wheel removed. Because the bicycle racks described above are configured to transport bicycles not motorcycles, they are generally not suitable and not adaptable for safely and securely transporting a motorcycle in an upright position in a pickup truck bed or on a trailer bed.

With regard to motorcycle carrier assemblies that are configured to carry motorcycles in the bed portion of a pickup truck or trailer, U.S. Pat. No. 6,109,494 to Pilmore and U.S. Pat. No. 4,057,182 to Kolkhorst describe to different configurations. The patent to Pilmore describes a motorcycle transport system that has a base portion which mounts to the floor of the bed and a bracket portion that permanently mounts to the frame of the motorcycle. For transporting purposes, the motorcycle is placed in the truck bed such that the bracket interconnects with the base to secure the motorcycle in an upright position. The patent to Kolkhorst describes a motorcycle carrier that has a vertical strut which mounts to the sidewall of the pickup bed and a hook member transversely mounted to the upper end of the vertical strut. The free end of the hook member has an upwardly opening hook contour that is engagingly received by a luggage rack or an added loop attached to the motorcycle so as to maintain the motorcycle in a preselected distance above the truck bed floor. Both of the aforementioned truck bed motorcycle racks require modifications to the motorcycle and require at least a portion of the assembly to be bolted, in a semi-permanent fashion, to the pickup truck bed. Another product, referred to as the Bed Buddy™ from CRC Sport, utilizes a front member having two or three wheel slots, depending on the size of the truck bed, and tie-down members having tie-down loops for securing the motorcycle(s) with tie-downs, rope, chain or locks. This apparatus mounts to the truck bed and must be selected based on the size of the truck (i.e., mini or full-size trucks). Several companies, such as Bike Pro, etrailer.com, Artisan Mfg., Inc. and Fisher Motorsport sell wheel chock apparatuses for receiving the front wheel of a motorcycle. At least a portion of these devices bolt to the floor, front or sides of a pickup truck bed.

As is generally known, many people also utilize pickup trucks and similarly configured vehicles for transporting work supplies, sporting equipment and other materials. Although pickup trucks generally have a rear cargo area that is suitable to carry a variety of materials, many people prefer to utilize a utility or truck rack to carry some of these materials. The use of a truck rack provides additional carrying capacity for the pickup truck and frees up the rear cargo area to carry larger or heavier weight materials. With regard to certain elongated or oversized materials, the use of a rack assembly is a necessity to prevent these materials from substantially extending beyond the rear of the vehicle or from being carried in an unbalanced condition (i.e., long ladders, canoes, pipes, wood or steel members and the like). Most truck racks allow these longer materials to be carried in a manner that extends the materials over the cab portion of the pickup truck.

The prior art discloses a wide variety of truck racks suitable for use with pickup trucks and similar vehicles. The typical pickup truck configured truck rack comprises a plurality of interconnected frame members that form the frame portion of the rack. Some of the known racks utilize frame members that are fixedly connected to each other, such as by welding or riveting, while other racks have frame members that are connected with bolts, screws and other removable connectors. Most known truck racks mount to the pickup truck by mechanisms that require drilling, welding or other modifications to the horizontally displaced load bearing bed and/or the upstanding forward wall, sidewalls and rear tailgate portions of the rear cargo area. Other racks utilize various clamping mechanisms to clamp the frame to the pickup truck or utilize connectors that are configured to being received in one or more stake pockets that are commonly disposed on the sidewall bedrails (i.e., the generally shaped, upper most portion of the sidewalls). For the typical truck rack, at least a portion of the frame rests on and is supported by the pickup truck's bedrails. Unfortunately, because the uppermost edge of some bedrails are not substantially horizontal, the truck rack frame is mounted on the bedrail at an undesirable angle, which can create load bearing and material carrying problems for the truck rack. As a result, in order to resist collapse and dislodging of the rack off the pickup truck due to shearing loads, the typical truck rack requires heavier weight frame members to provide the necessary support and carry the desired loads.

A number of prior art patents describe different configurations for truck racks for pickup trucks that are adaptable to carry various materials, including elongated or oversized materials, above the bed of a pickup truck. For instance, the prior art includes a number of truck racks that are bolted or otherwise attached to a pickup truck with one or more holes drilled in the pickup truck, as exemplified by U.S. Pat. No. 6,557,917 to Colcombe, U.S. Pat. No. 6,513,849 to Carter, U.S. Pat. No. D436,915 to Burger, U.S. Pat. No. 5,002,324 to Griffen and U.S. Pat. No. 4,676,543 to Lewis. The patents to Carter and Lewis also show that it is known to weld a part of the truck rack frame directly to the pickup truck. Each of these patents require modification to the pickup truck, a configuration many pickup truck owners find to be unacceptable. Other prior art pickup truck racks are configured to utilize one or more stake pockets, either to receive a frame member directly or with the use of stake pocket anchors, as exemplified by U.S. Pat. No. 6,347,731 to Burger, U.S. Pat. No. D444,446 to Carter, U.S. Pat. No. 5,806,905 to Moore, U.S. Pat. No. 5,692,791 to Sulzer, U.S. Pat. No. 5,190,337 to McDaniel, U.S. Pat. No. 4,659,131 to Plournoy, Jr., and U.S. Pat. No. 4,405,170 to Raya. Some of these patents, such as those to Sulzer and Raya, disclose the additional use of bolts, with holes drilled into the truck, and clamps to further secure the rack frame to the truck bedrail. Other patents disclose the truck racks that require at least one component to be mounted to the truck bed floor or sidewall, such as U.S. Pat. No. 4,509,787 to Knaack et al., U.S. Pat. No. 4,138,046 to De Freze and U.S. Pat. No. 3,891,262 to Brunel. A few patents, such as U.S. Pat. No. 6,340,106 to Dutton (FIG. 7) and U.S. Pat. No. 5,628,540 to James, disclose the use of clamping members to clamp a portion of the rack frame to the bedrail of the pickup truck.

Although the prior art discloses a number of truck racks for use with pickup trucks and the like, there are certain characteristics of these racks that limit their complete acceptance. For instance, some of these truck racks are not adaptable to different sized rear cargo areas or, if adaptable, only adaptable in a very limited range of sizes. Those truck racks that fixedly mount to the pickup truck reduce the flexibility of the truck owner or user for utilizing the rear cargo area for certain uses, such as carrying a camper shell or certain sized materials. In addition, those truck racks that have frame members fixedly attached to each other are generally not easy to install on or remove from the pickup truck. Even some of the truck racks that are configured to be taken on and off the pickup truck when desired are not necessarily easy to handle or install and remove, generally due to the size and/or weight of the individual frame members. Those truck racks that rely on engagement with or other use of the stake pocket are limited to those pickup trucks that have such components and, when used, foreclose the ability of the pickup truck user to utilize the stake pocket for other purposes.

As stated above, many of the current methods of securing a truck rack to a pickup truck or other vehicle require the user to drill at least one hole, and typically a plurality of holes, in his or her vehicle for receiving a bolt, screw or other connector to mount a portion of the truck rack to the truck. Unfortunately, this approach to securing a truck rack to a pickup truck has several drawbacks, the principal ones being the effort required to drill holes, having holes in the vehicle and having a truck rack that, while nominally removable, is not that easy to remove. As well known, holes drilled in a vehicle are not that easily repaired when it the user no longer desires to use the truck rack or when the pickup truck is to be sold. What is needed, therefore, is an improved clamp to secure a truck rack to a pickup truck or like vehicle that is easily installed on and removed from the vehicle without requiring the use of holes drilled in or other modifications made to the vehicle. The preferred clamp should be configured to securely, but removably, mount a variety of different types of truck racks to the bedrail of a pickup truck. The preferred clamp should be adaptable to a wide range of different sizes of truck racks and truck bedrails. The preferred clamp should also be compact and have a low profile in order to reduce the likelihood of the clamp being struck by cargo in the truck bed or interfering with the mounting of cross-bed tool boxes and other accessories on the truck or interfering with the loading of cargo over the bedrail into the bed.

### SUMMARY OF THE INVENTION

The clamp for truck racks of the present invention solves the problems and provides the benefits identified above. That is to say, the present invention discloses a clamp which is configured to securely mount a truck rack on the bedrail of a pickup truck or like vehicle without requiring any holes to be drilled in or other modifications made to the pickup truck. The clamp of the present invention is particularly configured to allow a user to easily install a truck rack on and remove it from a pickup truck bedrail. The clamp of the present invention is adaptable to truck racks and pickup trucks of different widths and lengths. The clamp of the present invention is particularly useful for those trucks that do not have stake pockets in the bedrail or for users who do not want to use the stake pockets for mounting the truck rack. The clamp of the present invention is compact and has a low profile, thereby reducing the likelihood of being struck by cargo in the truck bed or interfering with the mounting of cross-bed tool boxes and other accessories on the truck or the loading of cargo into the truck bed.

In one aspect of the present invention, the clamp for truck racks comprises a lower clamp assembly, an upper clamp assembly and a clamping mechanism for clamping the lower and upper clamp assemblies together in a manner that secures a base member of the truck rack to the bedrail of the pickup truck. The lower clamp assembly has a platform member on which an engaging member and an insert member are upwardly disposed. In one configuration the engaging and insert members are tubular components that attach to the upper surface of the platform member. Alternatively, the engaging member and insert members are integrally formed with the platform member. The engaging member has an upper end that engages the underside surface of the bedrail. Preferably, a generally compressible lower cushioning member is disposed at the upper end of the engaging member to protect the bedrail from damage. A mechanism for engaging the clamp is disposed at the upper end of the insert member. In a preferred configuration, the mechanism is a threaded aperture, which may be incorporated into a cap member that is attached to the upper end of the insert member. The upper clamp assembly has a clamp member and a channel member, which is attached to or integral with the clamp member, defining an insert channel sized and configured to receive the insert member. The preferred clamp member is L-shaped, with a generally horizontal, outwardly projecting first section and a generally vertical, downwardly projecting second section. In the preferred embodiment, one or more upper cushioning members are disposed on the lower side of the first section to protect the upper surface of the rack's base member.

The clamping mechanism is configured to engage the engaging mechanism of the insert member so as to clamp the lower and upper clamp assemblies together, with the base member and bedrail disposed therebetween. In one configuration, the channel member connects to the side of the clamp member's second section that faces into the truck's rear cargo area to define the insert channel. In this configuration, an L-shaped clamp plate is utilized to press downward on the clamp member and secure the base member against the bedrail. In the preferred embodiment, a connector passes through the clamp plate to engage the threaded aperture at the upper end of the insert member. In another configuration, the channel member connects to the side of the clamp member's second section that faces outward of the truck's rear cargo area to define the insert channel. In this configuration, no clamp plate is necessary. Instead, the first section of the clamp member is provided with an aperture, preferably in the form of a slot, through which a connector is placed so as to engage the threaded aperture at the upper end of the insert member. In the preferred embodiments, the connector is a screw which is configured with a security feature in its drive opening, such as one that requires a specially configured or proprietary bit to engage. When the clamp is utilized to secure the base member of a truck rack to the bedrail of a pickup truck, the connector presses the lower side of the clamp member's first section downward on the base member to clamp the clamp member against the top surface of the bedrail while the engaging member of the lower clamp assembly presses against the underside surface of the bedrail. Preferably, cushioning members on the clamp member and the insert member protect the finish on the base member and bedrail, respectively.

The clamp of the present invention has a broad padded surface that provides firm but gentle compression on the top surface of the base member of the truck rack to prevent damaging the base member. The clamp is low profile for better appearance and allowing utility items, such as tool boxes and the like, to be placed on the pickup truck's bedrail on or over the clamp. The clamp of the present invention has a sliding lower clamp assembly which allows the upper clamp assembly to remain in place while the lower clamp assembly is moved to avoid small obstructions, such as bedrail mounting clips and the like. The clamp has a compact design to prevent objects in the rear cargo area or on the bed from striking the clamp and getting hung up on it. The clamp of the present invention has a broad, linear design that hugs the pickup truck's bedrail and substantially prevents rotation of the upper or bottom clamp assemblies in relation to the bedrail and each other.

Accordingly, the primary objective of the present invention is to provide a clamp for truck racks that provides the advantages discussed above and that overcomes the disadvantages associated with presently available clamps for securing truck racks to pickup trucks.

It is an important objective of the present invention to provide a clamp that allows the user to securely mount a truck rack on the bedrail of a pickup truck without requiring holes be drilled into the bedrail or any other modifications be made to the pickup truck.

It is also an important objective of the present invention to provide a clamp that allows a user to relatively quickly and easily install a truck rack on the bedrail of a pickup truck and to remove the truck rack therefrom when use of the rack is not needed.

It is also an important objective of the present invention to provide a clamp for truck racks that is adaptable to a variety of different sizes and configurations of truck racks and pickup truck bedrails.

It is also an important objective of the present invention to provide a clamp for truck racks that clamps a base member of the truck rack onto the bedrail of a pickup truck between an upper clamp assembly having a clamp member which abuts the base member and a lower clamp assembly having an engaging member which abuts the underside of the bedrail.

It is also an important objective of the present invention to provide a clamp for truck racks that is configured to be generally compact and low profile in order to reduce the likelihood of the clamp being struck by cargo as the cargo is being loaded into the truck bed or interfering with the mounting of cross-bed tool boxes and other accessories on the truck or interfering with the loading of cargo over the bedrail into the truck bed.

It is also an important objective of the present invention to provide a clamp for truck racks that is adaptable for use to mount a truck rack on pickup truck bedrails that are not entirely parallel with the pickup truck bed.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a top perspective view of a pickup truck-type vehicle using a motorcycle rack to support a motorcycle in a generally upright position on the bed of the pickup truck;

FIG. 2 is a top perspective view of a trailer-type vehicle using a motorcycle rack to support a motorcycle in a generally upright position on the bed of the trailer;

FIG. 3 is a top plan view of the embodiment of a motorcycle rack showing use of side members as the support members and the use of both a cradling and a clamping wheel chock assemblies;

FIG. 4 is an isolated side view of the motorcycle rack shown in FIG. 3 showing the cradling wheel chock assembly;

FIG. 5 is a rearward facing (i.e., towards the back of the pickup truck or trailer beds in FIGS. 1 and 2) view of the motorcycle rack shown FIG. 3;

FIG. 6 is a rearward facing exploded view of the main body member for use with the motorcycle racks shown in FIGS. 1 and 2;

FIG. 7 is a perspective view of the clamp used with the motorcycle rack of FIG. 3;

FIG. 8 is an isolated rearward facing view of main body member used with the motorcycle rack of FIG. 3 and the clamp of FIG. 7;

FIG. 9 is a top plan view of the embodiment of the motorcycle rack showing use of leg/receiver members as the support members and the use of both a cradling and a clamping wheel chock assemblies;

FIG. 10 is a rearward facing (i.e., towards the back of the pickup truck or trailer beds in FIGS. 1 and 2) view of the motorcycle rack shown FIG. 9;

FIG. 11 is an isolated side view of the motorcycle rack shown in FIG. 9 showing the clamping wheel chock assembly;

FIG. 12 is an exploded rearward facing view of the leg and receiver members of the motorcycle rack of FIG. 9;

FIG. 13 is a partially exploded view of the components of the cradling wheel chock assembly for use with the motorcycle racks shown in FIGS. 1 and 2;

FIG. 14 is a partially exploded view of the components of the clamping wheel chock assembly for use with the motorcycle rack of FIGS. 1 and 2;

FIG. 15 is a side view of the clamping wheel chock assembly of FIG. 14;

FIG. 16 is a top view the motorcycle rack showing a wheel supported by a clamping wheel chock assembly;

FIG. 17 is a rearward facing view of a moveable tie-down for use with the motorcycle rack described herein.

FIG. 18 is a perspective view of a prior art truck rack mounted to the bedrail of a pickup truck utilizing a plurality of clamps configured according to a preferred embodiment of the present invention;

FIG. 19 is a perspective view of an alternatively configured prior art truck rack mounted to the bedrail of a pickup truck utilizing a plurality of claims configured according to a preferred embodiment of the present invention;

FIG. 20 is a top perspective view of a clamp configured according to a preferred embodiment of the present invention;

FIG. 21 is a top plan view of the clamp of FIG. 20;

FIG. 22 is a bottom plan view of the upper clamp assembly of the clamp of FIG. 20;

FIG. 23 is a side view of the clamp of FIG. 20;

FIG. 24 is an exploded side view of the clamp of FIG. 20

FIG. 25 is an isolated side view of the clamp of FIG. 20 shown clamping the base member of a truck rack to the bedrail of a pickup truck;

FIG. 26 is a top perspective view of an alternative configuration for the clamp of the present invention;

FIG. 27 is an exploded side view of the clamp of FIG. 26;

FIG. 28 is a top plan view of the clamp of FIG. 26;

FIG. 29 is a bottom plan view of the upper clamp assembly of the clamp of FIG. 26; and

FIG. 30 is an isolated side view of the clamp of FIG. 26 shown clamping the base member of a truck rack to the bedrail of a pickup truck.

### DETAILED DESCRIPTION OF THE PREFERRED EMBODIMENTS

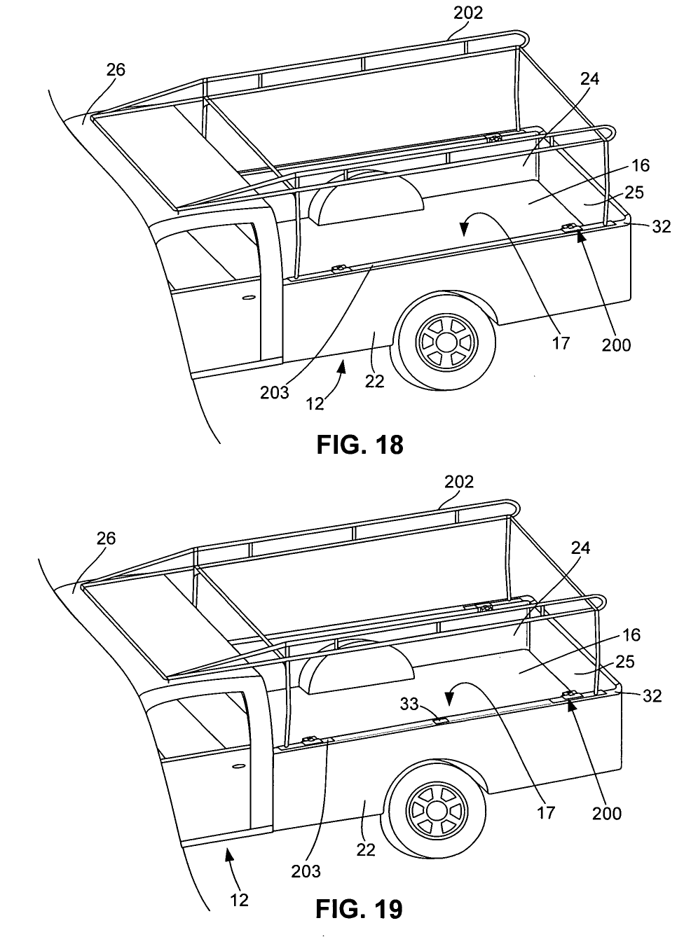

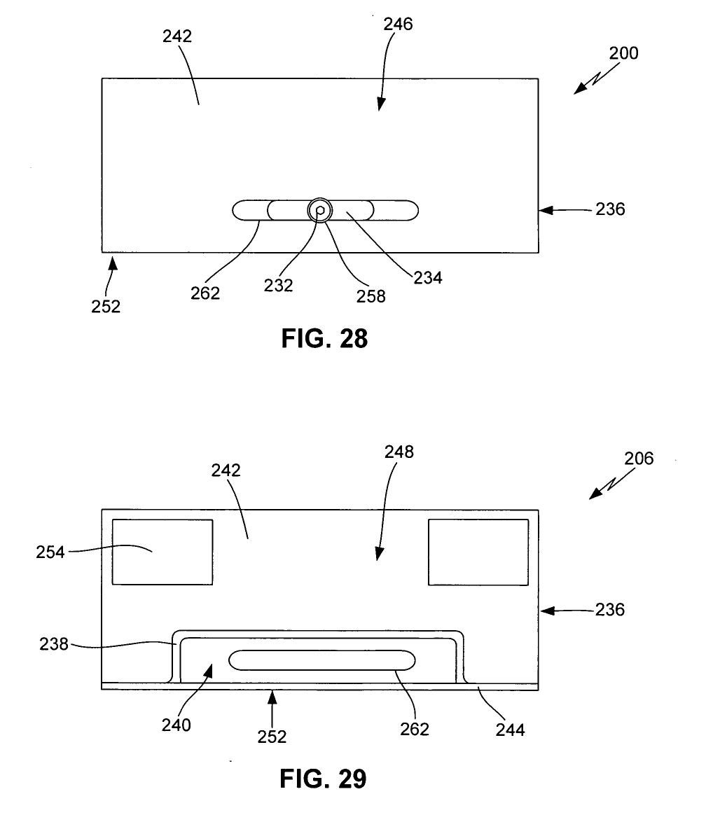

With reference to the figures where like elements have been given like numerical designations to facilitate the reader's understanding of the present invention, and particularly with reference to the embodiment of the clamp for truck racks of the present invention illustrated in FIGS. 18 through 30, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

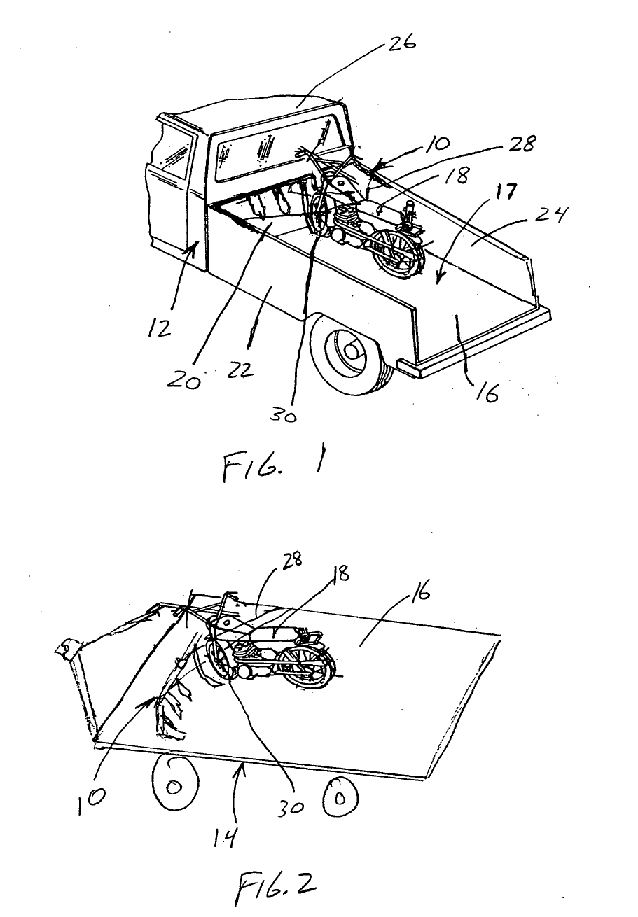

A motorcycle rack 10 is configured for use with pickup trucks 12, trailers 14 and similarly configured vehicles having a generally horizontally displaced load-bearing bed 16 on which can be placed a motorcycle 18 in a generally upright position, as shown in FIGS. 1 and 2. As shown in FIGS. 1 and 18-19, the typical pickup truck 12 has a rear cargo area 17 with bed 16 bounded on its periphery by at least a vertically displaced forward wall 20 opposing sidewalls, such as left sidewall 22 and right sidewall 24, and a tailgate 25. As is typical for pickup trucks 16, each of sidewalls 22 and 24 has a bedrail 32 at the top thereof that comprises a generally planar upper edge 34 and an inwardly disposed lip 36. The typical bedrail 32 may have one or more stake pockets 38 located thereon. A typical use for motorcycle rack 10 with pickup truck 12, as explained in more detail below, is to mount motorcycle rack 10 transversely across bed 16 at or near forward wall 20 immediately behind the forward cab portion 26 of pickup truck 12 and to utilize one or more ropes, straps, tie-downs or other flexible restraints, shown as 28, to secure motorcycle 18 to bed 16. Although motorcycle rack 10 can be placed elsewhere in rear cargo area 17, it is generally easier for loading and unloading purposes and a more efficient use of the space to place motorcycle 18 on bed 16 in a generally forward facing direction such that its front wheel 30 is held by motorcycle rack 10. On flatbed trailers and similar vehicles 14, an example of which is shown in FIG. 2, one or more motorcycle racks 10 can be placed on bed 16. Although it is not uncommon for trailers 14 have vertically displaced front and side walls similar to those for pickup trucks 12, many trailers 14 have bed 16 without front and side walls.

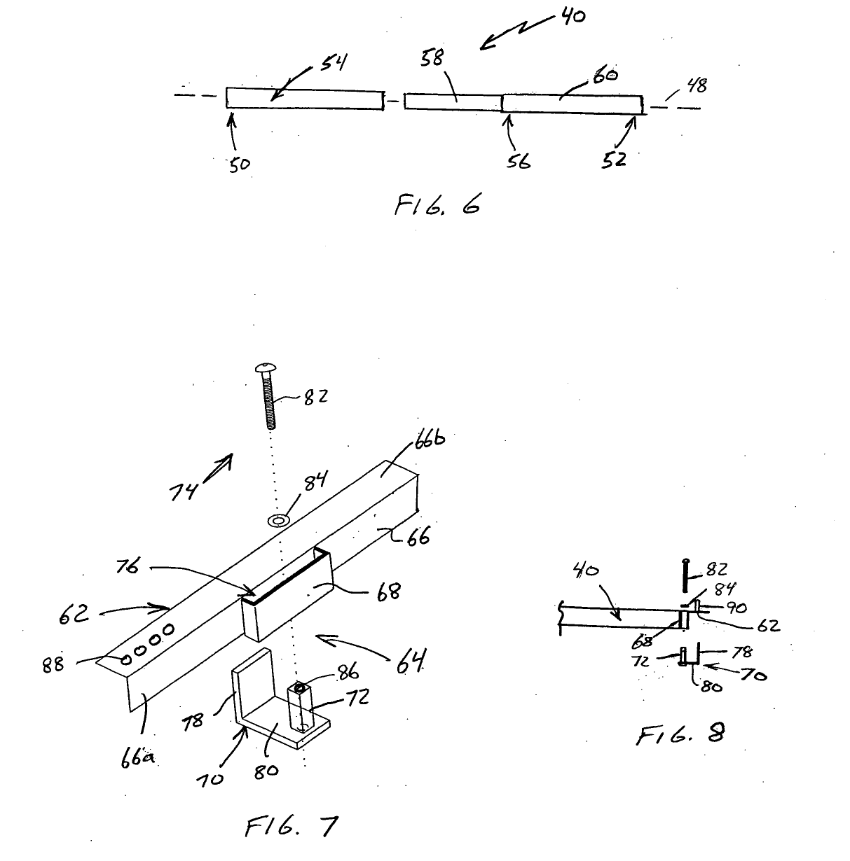

Motorcycle rack 10 is primarily comprised of an elongated main body member 40, first support assembly 42, second support assembly 44 and one or more wheel chock assemblies 46. As set forth in more detail below, these components function together allow the user of motorcycle rack 10 to safely and securely mount one or more motorcycles 18 in a generally upright position on bed 16 of a pickup truck 12 or trailer 14 for transport of motorcycles 18. In the preferred embodiments, shown in the figures, first support assembly 42 and second support assembly 44 are attached to main body member 40, also referred to as a spanner, and configured so as to transversely support main body member 40 in a substantially horizontal position above bed 16 of pickup truck 12 or trailer 14. In the configuration set forth in FIGS. 1 and 2, main body member 40 transversely spans substantially the entire width of bed 16. The placement of main body member 40 at forward wall 20 protects forward wall 20 and cab portion 26 from damage caused by contact with motorcycle 18, either during the loading/unloading process or during transport. Main body member 40 can be made out of various sized and shaped materials, such as the square tubular material (shown in FIG. 4), having principal longitudinal axis 48 and first main body end 50 and second main body end 52, as best shown in FIG. 6.

Various materials can be used for the components of motorcycle rack 10. For instance, main body member 40, first support assembly 42, second support assembly 44 and wheel chock assembly 46 can be made out of metal, fiberglass, composites, certain plastics and various other materials and combinations of materials that have sufficient strength, rigidity, durability and corrosion resistance for the components of motorcycle rack 10. If desired, coated or covered materials can be used to provide the necessary corrosion resistance for use as an apparatus exposed to the outside elements. It is desirable that main body member 40 be made out of material that is sufficiently strong to resist damage from contact with motorcycle 18 and to prevent damage to forward wall 20 and/or cab portion 26 of pickup truck 12. In addition, main body member must have sufficient size and strength to support one or more wheel chock assemblies 46 and motorcycles 18 used with motorcycle rack 10.

Although motorcycle rack 10 can be configured with a particular length of main body member 40 to fit a specific width bed 16, the preferred embodiment of motorcycle rack 10 has main body member 40 configured to be longitudinally adjustable in length so that a single motorcycle rack 10 may be utilized on a variety of different sized pickup trucks 12 and trailers 14 having different widths of bed 16. In a preferred embodiment, best shown in FIG. 6, main body member 40 is comprised of two or more separate substructures, such as first telescoping member 54 and second telescoping member 56, that cooperate together in a telescoping manner to allow the user to lengthen or shorten the longitudinal length of main body member 40 to fit different sizes of bed 16. In the preferred configuration, second telescoping member 56 is sized and configured to be insertably received by first telescoping member 54. This can be achieved by configuring second telescoping member 56 to have a reduced cross-section portion 58 at the end to be received by first telescoping member 54. Reduced cross-section portion 58 of second telescoping member 56 can be a separate component that is fixedly attached to the enlarged portion 60 by welding, use of adhesives, use of bolts, screws, rivets or other connectors, or by other forms of joining two members of different cross-sectional sizes that are known in the art. Alternatively, second telescoping member 56 can be a single member having a reduced cross-section portion 58 cut or otherwise manufactured from that single member. The length of reduced cross-section portion 58 must be sufficient enough in order to maintain the alignment of the first telescoping member 54 and second telescoping member 56 along a generally common axis and to resist forces that are right angle to that axis. When properly configured with the enlarged portion 60 being the same size as first telescoping member 54 and the use of reduced cross-section portion 58 is that when first telescoping member 54 and second telescoping member 56 are joined together, with the reduced cross-section portion 58 inside first telescoping member 54, the appearance will be of a single sized main body member 40.

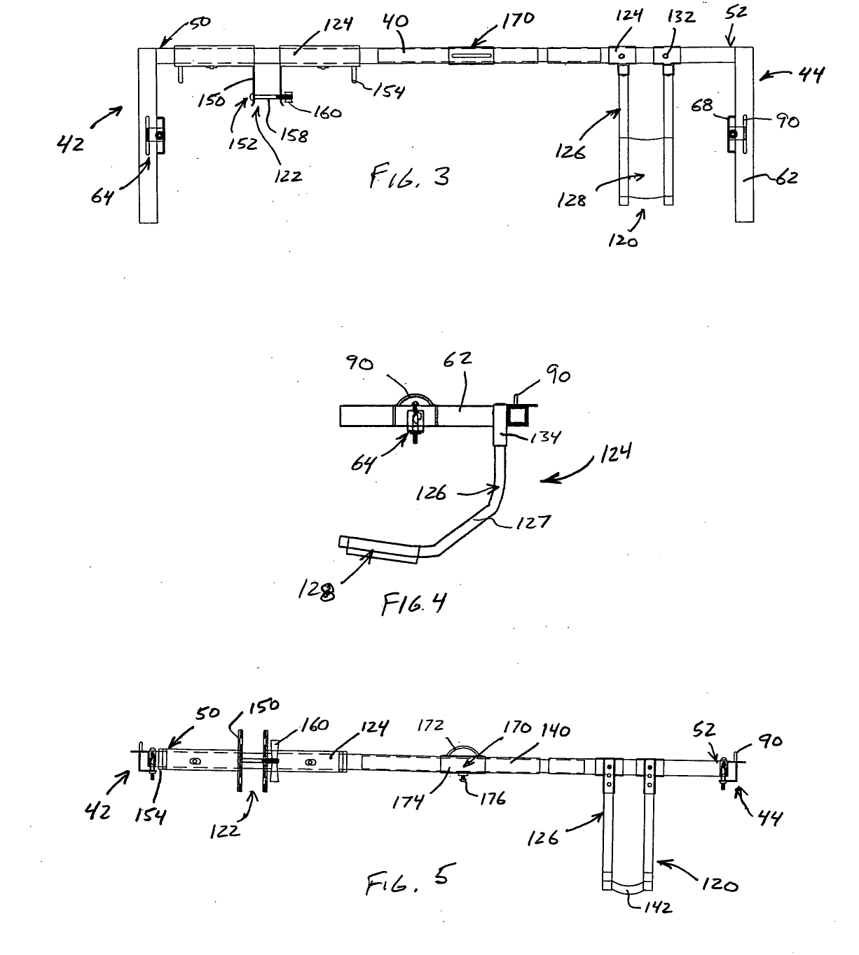

In the figures, first support assembly 42 is shown attached to first main body end 50 and second support assembly 44 is shown attached to second main body end 52 of main body member 40. When used with trucks or other vehicles having sidewalls, such as left sidewall 22 and right sidewall 24 shown in FIG. 1, motorcycle rack 10 can utilize a pair of support assemblies, such as first support assembly 42 and second support assembly 44, that attach to the top of vertically displaced left 22 and right 24 sidewalls, respectively, as generally shown in FIG. 1. In this configuration, support assembly 42 and/or 44 can comprise side member 62 that is supportably attached to sidewalls 22 or 24 and clamp 64 configured to fixedly, but removably, clamp side member 62 to sidewall 22 or 24 such that side member 62 is held down against the upper edge 34 of bedrail 32 of sidewall 22 or 24. In the embodiment shown in FIG. 7, side member 62 comprises a generally L-shaped member 66 that abuts the inside (i.e. towards bed 16) and upper portions of sidewall 22 or 24. In this manner, one side of the L-shaped member 66 is oriented generally horizontally atop sidewall 22 or 24 and the other side is oriented generally vertically on the inside of sidewall 22 or 24. Side member 62 can be placed anywhere on sidewall 22 or 24 where it is desired to mount motorcycle rack 10. Typically, a pair of side members 62 will be placed on opposite sidewalls 22 and 24 in a corresponding relationship generally across bed 16 from each other with main body member 40 disposed between. As best shown in FIGS. 3 and 5, one end of side member 62 will be attached to suitable for attachment to either first main body end 50 or second main body end 52 of main body member 40. In the preferred embodiment, first main body end 50 of main body member 40 is fixedly attached in a generally right angle relationship to the vertically disposed component 66a of L-shaped member 66 of first support assembly 42 and second main body end 52 of main body member 40 is fixedly attached in a generally right angle relationship to the vertically disposed component 66a of L-shaped member 66 of second support assembly 44. Attachment of side member 62 to either first main body end 50 or second main body end 52 can be accomplished by welding or other fixed means, by bolting, riveting or other attachment mechanisms or by forming side members 62 and main body member 40 out of a single piece of material.

To effectively and safely support main body member 40 and motorcycle 18 in or on bed 16, first 42 and second 44 support assemblies having side members 62 should be fixed, albeit preferably temporarily, to left 22 and right 24 sidewalls. In a preferred embodiment, shown in FIGS. 3, 4 and 5, each of first 42 and second 44 support assemblies utilize clamp 64 to selectively clamp side member 62 to sidewalls 22 and 24. Preferably, clamp 64 is of the type that is adaptable for a variety of configured sidewalls 22 or 24, easy to install and remove and effective at tightly holding support assemblies 42 and 44 on sidewalls 22 and 24. In the preferred embodiment, best shown in FIG. 7, clamp 64 comprises a channel member 68 affixed to the inside of side member 62 (i.e., on vertically disposed component 66a towards bed 16 and interior of rear cargo area 17), a clamp hook 70 configured to clamp against sidewall 22 or 24, a clamp tube 72 on clamp hook 70, and a clamping mechanism 74 configured to clamp and un-clamp side member 62 from sidewalls 22 and 24 as desired to install or remove motorcycle rack 10. Channel member 68 is fixed, by welding or other means, to side member 62 such that it forms, with side member 62, channel 76 sized and configured for receiving clamp tube 72 therein. As shown in FIG. 7, the top of channel member 68 should be substantially level with the horizontally disposed component 66b of side member 62.

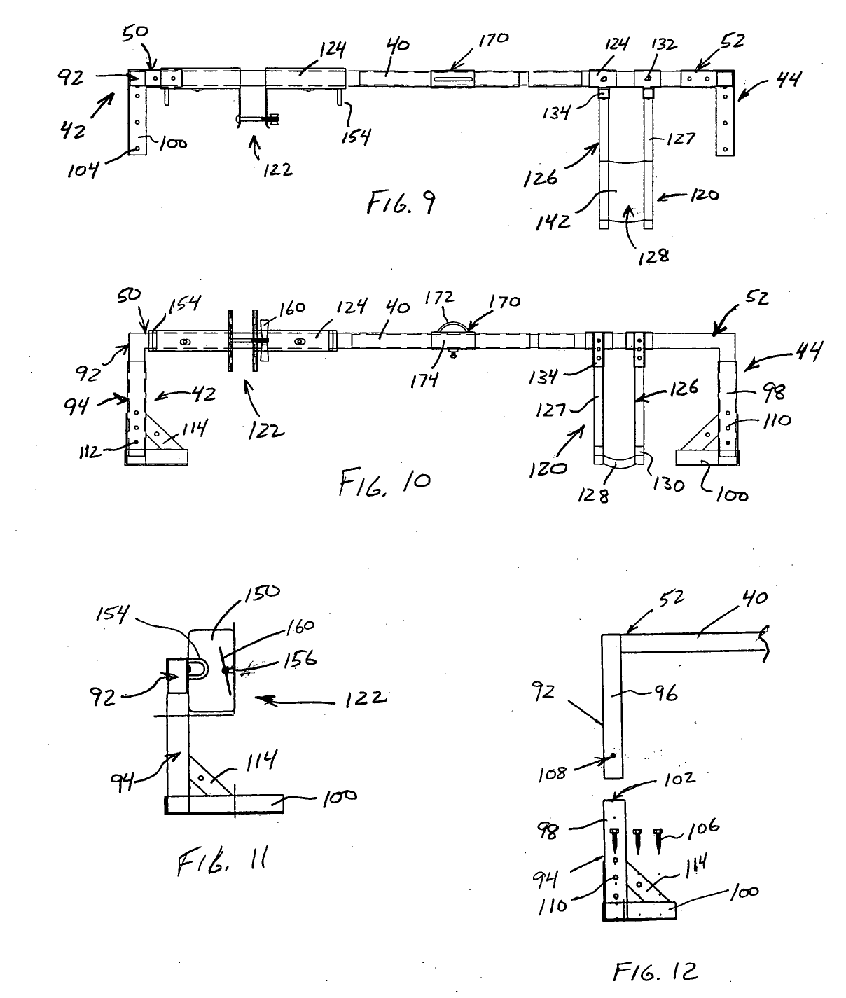

As best shown in FIGS. 7 and 8, clamp hook 70 is comprised of an upwardly extending portion 78 and an inwardly extending portion 80 configured together in a generally L-shaped configuration. Clamp tube 72 is affixed at or near the inside end (i.e., bed 16 side) of inwardly extending portion 80 and configured to extend upward, so as to form a generally U-shaped member with clamp hook 70, and fit inside channel 76. The upwardly extending portion 78 is configured to extend upward into the bedrail channel space (not shown) at the top of sidewalls 22 and 24 on pickup truck 12 when side member 62 is abutting the inside and upper portions of sidewalls 22 and 24 and clamp tube 72 is inside channel 76. The top of upwardly extending portion 78 can be flattened or rounded so as to provide a blunt contact point with the underside surface of the bedrail channel so as to improve the contact for the desired clamping action. Because clamp tube 72 fits tightly inside channel 76, clamp hook 70 is effectively prevented from rotating around the axis of clamp member 74. Clamping mechanism 74 is configured to be removably received by clamp hook 70 such that it causes clamp 64 to securely clamp side member 62 to sidewall 22 or 24. In the preferred embodiment, clamping mechanism 74 is an externally threaded screw 82 that is used with washer 84 to abut the top of channel member 68 and side member 62 so as to pull upwardly extending portion 78 against the underside of the bedrail channel space at the top of left 22 or right 24 sidewall. Also in the preferred embodiment, shown in FIG. 7, clamp tube 72 has bore 86 therethrough having an internal diameter slightly larger than the diameter of screw 82 that allows screw 82 to pass through to a threaded hole (not shown) in inwardly extending portion 80 below clamp tube 72 where screw 82 is threadably received therein to allow clamping mechanism 74 to draw clamp hook 70 upward so as to secure side member 62 to left 22 or right 24 sidewall. In an alternative configuration, bore 86 of clamp tube 72 is internally threaded for threadably receiving screw 82 in clamp tube 72. Once clamped, clamp 64 tightly holds side member 62 of first 42 or second 44 support assembly in place on left 22 or right 24 sidewall so that main body member 44 extends generally transversely across bed 16 to another support member (i.e., first 42 or second 44 support assembly), as shown in FIG. 1. When not fully tightened, side member 62 and clamp 64 may be slid horizontally along the top of sidewall 22 or 24 and inside the bedrail channel to the best location on sidewall 22 or 24 to avoid any obstructions under the bedrail 32.

If desired, certain components of side member 62 and clamp 64 may be coated with or made out of materials that are less likely to scratch or otherwise damage left 22 or right 24 sidewalls of pickup truck 12. For instance, the underside portion of vertically disposed component 66a and horizontally disposed component 66b of L-shaped member 66 and the inside portion of upwardly extending portion 78 and inwardly extending portion 80 of clamp hook 70 can be coated or otherwise covered. One or more holes 88 can be provided along horizontally disposed component 66b, as shown in FIG. 7, through which a bolt (not shown) projecting up from or down into an opening (not shown) in the top of sidewall 22 or 24, commonly referred to as a stake pocket 38, can connect with commonly available hardware in the stake pocket 38 to further bolt that portion of side member 62 to sidewall 22 or 24. In addition, side member 62 can have one or more loop members 90, as shown in FIGS. 3 through 5 and 8, thereon for use as a tie-down hold to assist the user in securing motorcycle 18 with ropes, straps or other tie-down devices.

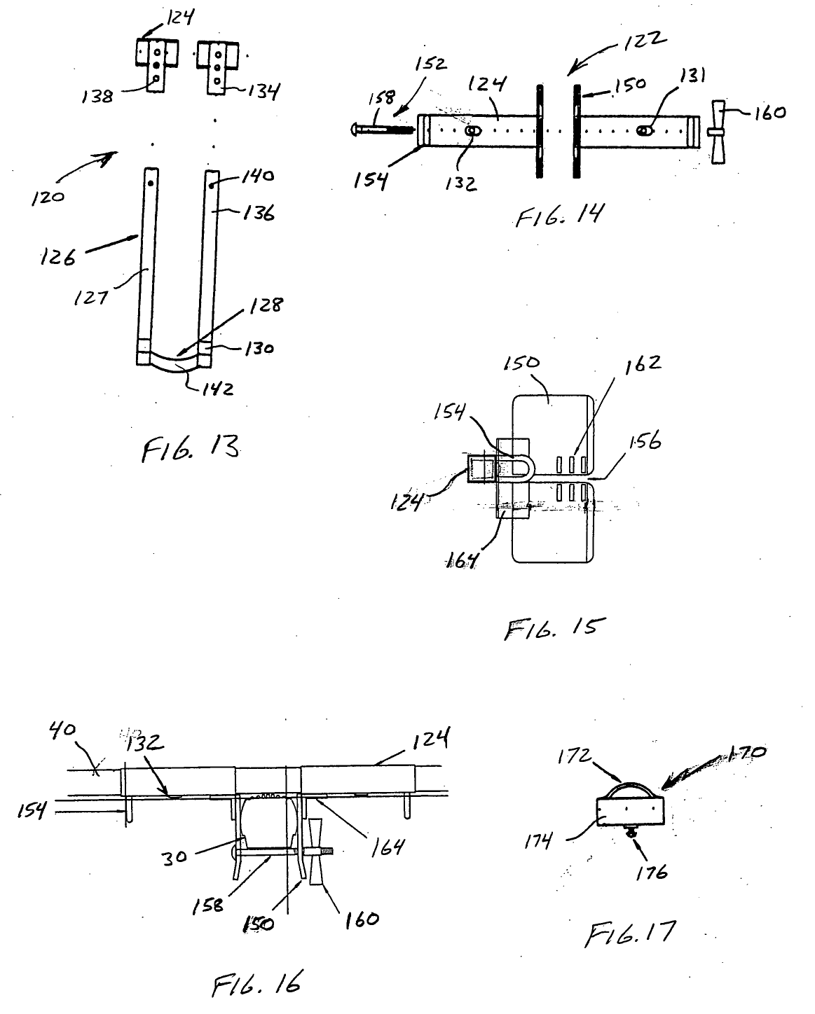

When attachment of first support assembly 42 and/or second support assembly 44 to the left sidewall 22 and/or right sidewall 24 is not possible (i.e., when trailer 14 shown in FIG. 2 is utilized) or desirable, such as when a camper shell or other cover is placed on pickup truck 12, support assembly 42 and/or 44 can be removably mounted directly on bed 16. In this configuration, as shown in FIGS. 9 through 12, support assembly 42 and/or 44 can comprise leg member 92 attached to first main body end 52 and/or second main body end 54 of main body member 40 and receiver member 94 mounted to bed 16. In the preferred embodiment, best shown in FIGS. 10 through 12, leg member 92 is a leg tubular member 96 welded at its upper end to first main body end 52 and/or second main body end 54 and receiver member 94 comprises a receiver tubular member 98 that is welded or otherwise fixedly connected in a generally upright position to base member 100 such that opening 102 at the top of receiver tubular member 98 is upwardly facing. If desired, receiver tubular member 98 can be removably attached to base member 100. As shown in FIGS. 10 and 11, the outside diameter of leg tubular member 96 is configured to be smaller than the inside diameter of opening 102 and receiver tubular member 98 so that leg tubular member 96 can be removably received inside receiver tubular member 98. Base member 100 has one or more base holes 104 to allow receiver 94 to be screwed, with screws 106, or bolted to bed 16 so it may be removed from bed 16 as necessary or desired. Alternatively, base member 100 may be welded, riveted or attached by a variety of other mechanisms to bed 16. To allow for an adjustment of height for motorcycle rack 10, leg tubular member 96 can comprise one or more leg holes 108 and receiver tubular member 98 can comprise one or more receiver holes 110 such that when leg tubular member 96 is inside receiver tubular member 98 a connector 112 can be used to connect leg member 92 to receiver member 94. If leg holes 108 and receiver holes 110 pass through leg tubular member 96 and receiver tubular member 98, respectively, then connector 112 can be a retainer pin or like device, otherwise connector 112 can be a snap-button or like device. As shown in FIGS. 10 through 12, one or more reinforcing members, such as gussets 114, can be utilized to support and maintain the generally vertical orientation, relative to base member 100, of receiver tubular member 98.

As set forth above, motorcycle rack 10 will have one or more wheel chock assemblies 46 attached to main body member 40. In the preferred embodiment, each wheel chock assembly 46 is configured to be slidably received on main body member 40 so that wheel chock assembly 46 may support motorcycle 18 on bed 16 where most desired. One configuration for wheel chock assembly 46 is the cradling wheel chock assembly identified as 120 in the figures. Another configuration for wheel chock assembly 46 is the clamping wheel chock assembly identified as 122 in the figures. Both wheel chock assemblies 120 and 122 utilizes one or more horizontally disposed tubular connection members 124 shaped and configured to generally correspond to the shape of main body member 40 and have an inside circumference slightly larger than the outside circumference of main body member 40. As best shown in FIGS. 3, 5, 9 and 10, connection members 124 are mounted annularly onto main body member 40 so that they can be slid anywhere along main body member 40 where desired. Each connection member 124 has a threaded hole (shown as 131 in FIG. 14) in one face that accepts a setscrew 132 for fixing the position of the connection member 124 on main body member 40. As set forth below, different mechanisms for holding the front wheel 30 of motorcycle 18 are utilized depending on whether wheel chock assembly 46 is configured with the cradling wheel chock assembly 120 or clamping wheel chock assembly 122.

Cradling wheel chock assembly 120 comprises frame 126 having two or more frame members 127, one or more wheel support assemblies 128 and one or more securing mechanisms 130. Frame 126 of cradling wheel chock assembly 120 attaches to connection member 124. In the preferred embodiment, best shown in FIG. 13, frame 126 comprises a small tubular receiver 134 and side tubes 136. Tubular receiver 134 is fixedly attached (i.e., welded, bolted, screwed, etc.) to each connection member 124 for slidably receiving a side tube 136 therein. To facilitate the connection between tubular receiver 134 and side tube 136, tubular receiver 134 has one or more holes 138 in a substantially vertical line. In the preferred embodiment, a vertical plate (not shown) is welded to the inside edge of tubular receiver 134 in a substantially right angle relationship with main body member 40 and positioned such that it extends outwardly away from main body member 40 to serve as a guide and lateral support for front wheel 30 of motorcycle 18. In the preferred embodiment, each side tube 136 is a metal tube having an outside circumference slightly smaller than the inside circumference of tubular receivers 134. Near the top end of each side tube 136 is a hole containing a snap-button connector 140. When the top end of each side tube 136 is inserted into the bottom of each tubular receiver 134, snap-button connector 140 snaps into one of holes 138 in the vertical tube of tubular receiver 134, thereby fixing the height of side tubes 136 in the tubular receiver 134. Frame members 127 extend generally downward from connection members 124 and then bend away in a generally arcuate shape from main body member 40 (i.e., toward the tailgate in pickup truck 12) until they are generally horizontal relative to bed 16, as best shown in FIG. 4.

In the preferred embodiment for clamping wheel chock assembly 120, wheel support member 128 comprises one or more flexible bands 142 consisting of one or more straps of woven fabric or other flexible material that form loops on each side of the bands 142, as best shown in FIG. 13. Each loop has an inside circumference slightly larger than the outside circumference of side tubes 136 and slips over the bottom end of each side tube 136. Flexible bands 142 are long enough to allow front wheel 30 (i.e., tire) of motorcycle 18 to sink down into the middle of support member 128 and draw side tubes 136 together against the side of wheel 30. Securing mechanism 130 on each side tube 136 comprises a band retention clip consisting of rigid bands attached to the bottom side near the back end of side tubes 136. The band retention clip bands run generally parallel to the bottom of side tubes 136 and bend back upon themselves just beyond the ends of flexible bands 142 in such a way as to retain flexible bands 142 in place to prevent them from sliding forward or backward along side tubes 136. In one configuration, securing mechanism 130 (i.e., band retention clips) are held in place by means of a rivet, screw, or other device located near the middle, between flexible bands 142. A washer (not shown) inserted between the top and bottom part of the clip 130 around the rivet creates a gap between the sides of the clip 130. This allows limited rotation of flexible bands 142 around side tubes 136.

The preferred embodiment of clamping wheel chock assembly 122, best shown in FIG. 14, comprises a pair of vertical clamp plates 150, each of which is fixedly attached to a horizontal disposed tubular connection member 124, and a plate connector 152 configured to clamp the pair of clamp plates 150 against the front wheel 30 of motorcycle 18. Each plate 150, which is preferably taller than it is wide, extends away from main body member 40 (i.e., rearward toward the tailgate of a pickup truck 12), and is welded to the rear-facing surface of connection member 124 near the interior end of connection member 124, as best shown in FIGS. 3 and 9. Also in the preferred embodiment, a fixed tie-down hold 154, also best shown in FIGS. 3 and 9, is welded to the surface of each connection member 124 at the end opposite clamp plate 150. A threaded hole containing a setscrew 132 is located in the center of connection member 124 approximately half way between clamp plate 150 and the tie-down hold 154. As best shown in FIG. 15, each clamp plate 150 contains a horizontal slot 156 that extends and inch or more from the rear edge of clamp plate 150 toward the front of bed 16. When clamping wheel chock assembly 122 is mounted on main body member 40 and a motorcycle wheel 30 has been placed into the chock assembly 122, as shown in FIG. 16, plate connector 152 is placed within the rim of the wheel 30 and slid forward within the slots 156 in each clamp plate 150. In the preferred embodiment, plate connector 152 comprises carriage bolt 158 with a square shaft or head on one end and a wing nut 160 threaded on the other end. Preferably, the head of carriage bolt 158 has a square base that is only slightly smaller than the width of slot 156. Bolt 158 extends from one clamp plate 150 to the other, with the head of bolt 158 pressing against the outer face of one clamp plate 150 and the body of wing nut 160 pressing against the face of the other. When wing nut 150 is tightened, it draws the head of bolt 158 towards it and clamp plates 150 are drawn together to firmly squeeze the sides of wheel 30. Also in the preferred embodiment, as shown in FIG. 15, each clamp plate 150 has a series of raised ridges 162 on the outside face of each clamp plate 150 extending out from slot 156. When tightened, bolt 158 and wing nut 160 can no longer slide freely within slot 156 due to the raised ridges 162 on each clamp plate 150 preventing the head of bolt 158 or wing nut 160 from moving horizontally along slot 156. Moreover, bolt 158 will not be able to rotate due to the base of the head of bolt 158 being square and the flats of the square making contact with the sides of slot 156 when bolt 158 begins to rotate. If desired, angle support 164 can be placed at the corner of clamp plate 150 and connection member 124, as shown in FIGS. 15 and 16, to provide additional support for clamp plates 150.

In addition to the fixed tie down devices, such as tie down loops 90 on side members 62 and fixed tie-down holds 154 on connection members 124, the preferred embodiment of the motorcycle rack 10 includes one or more moveable tie-downs 170, as shown in FIGS. 3, 5, 9 and 10. As best shown in FIG. 17, moveable tie-down 170 of the preferred embodiment includes one or more loop members 172 fixedly attached to a tubular member 174 that is sized and configured to be slidably disposed on main body member 40. In use, moveable tie-downs 170 are mounted annularly to the main body member 40 and are used to provide additional anchor points to attach the tie-down straps 28 for the motorcycle(s) 18. The inside circumference of tubular member 174 is slightly larger than the outside circumference of main body member 40 to allow moveable tie-down 170 to be slid anywhere along main body member 40. In the preferred mechanism, a setscrew 176 on the side of tubular member 174 is utilized as a mechanism for fixing moveable tie-down 170 in place after removably positioning it where desired. As is known in the art, instead of using setscrew 176 to removably position moveable tie-down 170 on main body member 40, motorcycle rack 10 could utilize bolts, screws, clamps, pins and other devices to fix the position of tie-down 170.

In use, the user of motorcycle rack 10 will decide whether he or she wants to use one or more cradling wheel chock assemblies 120, one or more clamping wheel chock assemblies 122 or some combination of these two types of wheel chock assemblies, such as one of each as shown in FIGS. 3, 5, 9 and 10. Also, depending on the circumstances, such as whether vehicle 12 or 14 has sidewalls and whether the sidewalls are available for use, or preferences, the user will decide whether first support assembly 42 and second support assembly 44 will either comprise a pair of side member 62 and clamp 64 components, a pair of leg member 92 and receiver member 94 components or a combination of one side member 62 and clamp 64 and one leg member 92 and receiver member 94. The tubular connection members 124 for wheel chock assemblies 120 and 122 and the tubular member 174 of any moveable tie-downs 170 to be utilized, are slid onto and over main body member 40 prior to reduced cross-section portion 58 of second telescoping member 56 being inserted into first telescoping portion 54 to form the adjustable length main body member 40. If the side member 62 and clamp 64 components are utilized as first 42 and/or second 44 support assemblies, such as shown in FIG. 1, side member 62 of first support assembly 42 is placed on top of left sidewall 22 and side member 62 of second support assembly 44 is placed on top of right sidewall 24 such that main support member 40 is transversely disposed across bed 16 between first 42 and second 44 support assemblies. A clamp 64 is placed on each side member 62 to secure them to sidewalls 22 and 24. If the leg member 92 and receiver member 94 components are utilized as first 42 and/or second 44 support assemblies, such as shown in FIG. 2, leg tubular member 96 is slid into receiver tubular member 98 and the desired height for main body member 40, which will be transversely disposed across bed 16 between first 42 and second 44 support assemblies, is selected with connector 112. If base member 100 is not fixedly mounted on bed 16 or attached to bed 16, it would need to be done so to secure motorcycle rack 10 to bed 16 (preferably prior to connecting the leg members 92 and receiver members 94 together).

When the cradling wheel chock assembly 120 is utilized, the front motorcycle wheel 30 is rolled into chock assembly 120 until the front of the tire 30 makes contact with main support member 40 (as shown in FIG. 16 for clamping wheel chock assembly 122) and the bottom of the tire 30 rests upon flexible bands 142 of wheel support member 128 at the base of cradling wheel chock assembly 120. The weight of the wheel 30 pushes down on wheel support member 128 such that it draws frame 126 of cradling wheel chock assembly 120 against wheel 30, applying firm lateral pressure to temporarily holding motorcycle 18 in an upright position and permitting the operator to tie down motorcycle 18 with restraints 28 without having to hold motorcycle 18 up at the same time. Cradling wheel chock assembly 120 cradles front wheel 30 and keeps it elevated above the floor of bed 16 so when the tie-down straps 28 from motorcycle 18 to rack 10 are tightened, the force of this tension is held primarily within motorcycle rack 10, rather than being transferred to the floor of bed 16, thereby, thus reducing the uplifting force which would otherwise tend to pry rack 10 upward off the surface to which it is attached. When clamping wheel chock assembly 122 is used, motorcycle wheel 30 is pushed forward into chock 122 until the wheel 30 makes contact with main support member 40. Bolt 158 with wing nut 160 is placed between the spokes of wheel 30 and within the internal diameter of the rim. When wing nut 160 is tightened, it draws the sides of clamping wheel chock assembly 122 very firmly against the sides of wheel 30 while bolt 158 blocks rearward movement, thus allowing motorcycle 18 to stand upright without assistance from the operator, and in the case of light-weight motorcycles 18, without using tie-downs or other restraints 28. Once in place, motorcycle 18 can be safely transported on bed 16 of pickup truck 12 or trailer 14.

The clamp of the present invention, identified generally as 200 in FIGS. 18 through 30, is shown in use with a typical, prior art truck rack 202 in FIGS. 18 and 19 to secure truck rack 202 to bedrail 32 of pickup truck 12. As with clamp 64 discussed above with regard to motorcycle rack 10, clamp 200 is configured to securely mount truck rack 202 to the upper edge 34 of bedrail 32 so that the user may place materials and/or supplies on truck rack 202 and transport them with pickup truck 12. As shown in FIGS. 18 and 19 and set forth in more detail below, clamp 200 is configured to securely clamp base member 203 of truck rack 202 so as to mount truck rack 202 to bedrail 32 of the left 22 and right 24 sidewalls, which define rear cargo area 17 with bed 16, of pickup truck 12. Truck rack 202 of FIG. 18 has a base member 203 which extends the full length or substantially the full length of bedrail 32, whereas the truck rack 202 of FIG. 19 has a plurality of base members 203 which do not extend the full length of bedrail 32. In general, the type of truck rack 202 having the full length base member 203 of FIG. 18 is preferred to better avoid the tendency of the legs of rack 202 to rotate under load. As will be readily apparent to those skilled in the art, clamp 200 can be utilized with a wide variety truck racks, including but not limited to the configuration of truck rack 202 shown in FIGS. 18 and 19. Clamp 200 of the present invention, configured for use with truck rack 202, has many of the same features and function as clamp 64 discussed above.

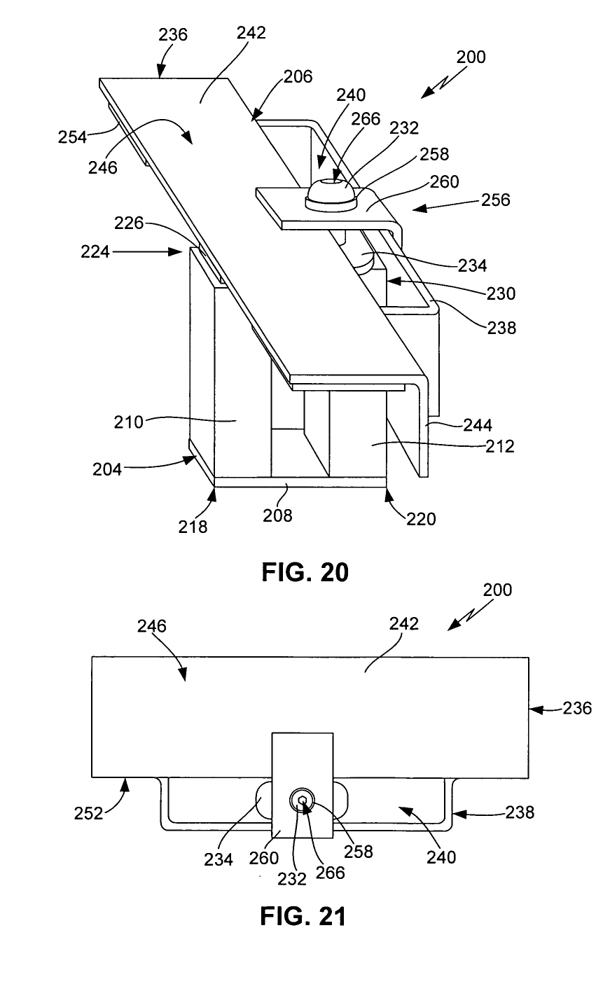

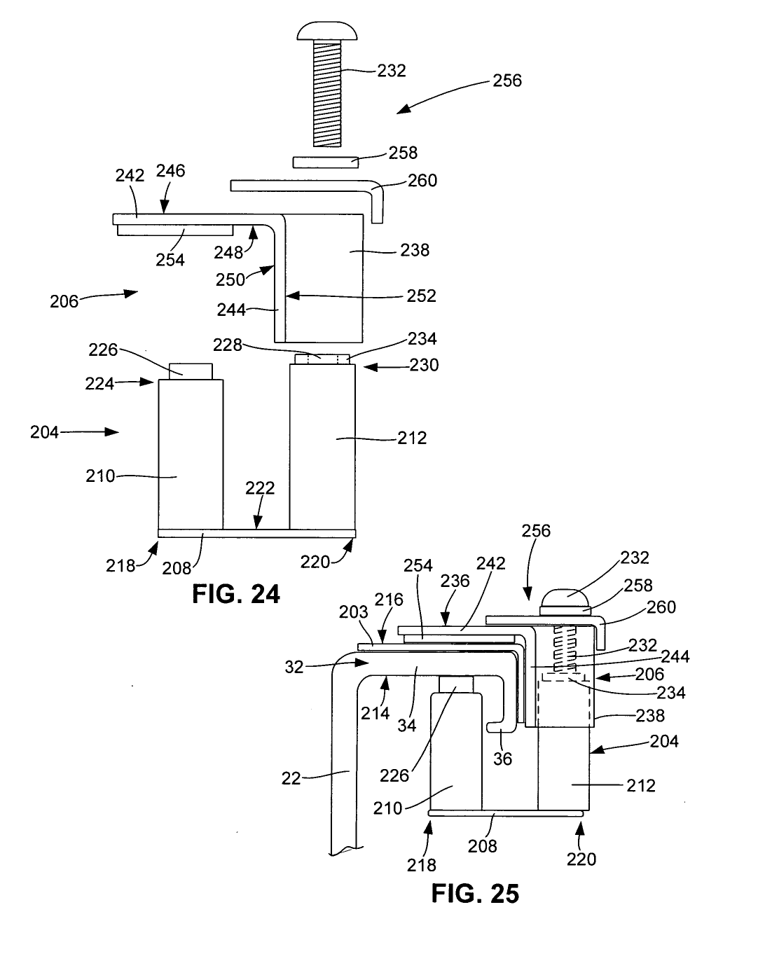

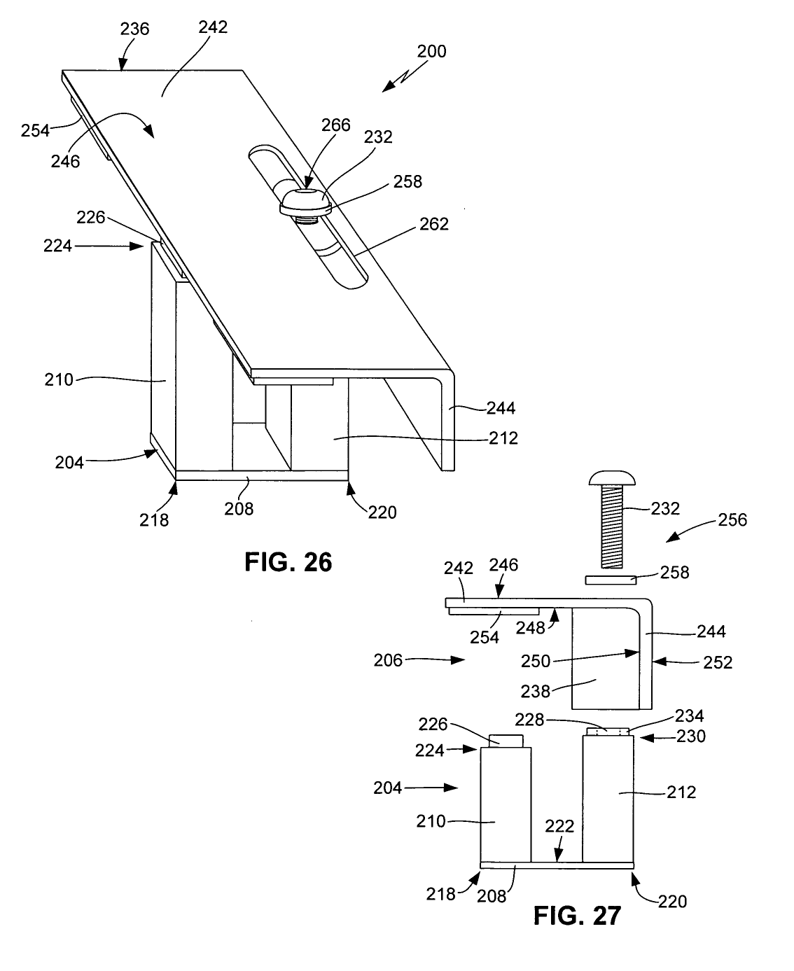

In the preferred embodiments of the present invention, clamp 200 generally comprises a lower clamp assembly 204 and a cooperatively configured upper clamp assembly 206. Two configurations of clamp 200 are shown in the figures, one in FIGS. 20 through 25 and one in FIGS. 26 through 30. In both configurations, lower clamp assembly 204 is the same component. In the preferred embodiments, lower clamp assembly 204 comprises a platform member 208 having an upwardly extending engaging member 210 and an upwardly extending insert member 212, as best shown in FIG. 24. As explained in more detail below and shown in FIG. 25, engaging member 210 is configured to engage the underside surface 214 of the upper edge 34 of bedrail 32 and insert member 212 is sized and configured to engage upper clamp assembly 206 when clamp 200 is utilized to securely mount truck rack 202 onto the top surface 216 of upper edge 34 of bedrail 32. As best shown in FIG. 24, platform member 208 is a generally horizontally disposed, planar member having a first end 218, a second end 220 and an upwardly facing upper surface 222, with engaging member 210 disposed on upper surface 222 at or near the first end 218 and insert member 212 disposed on upper surface 222 at or near the second end 220 thereof. As shown, engaging member 210 and insert member 212 are in spaced apart relation in order to prevent contact between bedrail 32 and lower clamp assembly 204, except at the upper end 224 of insert member 212 (as described below). Platform member 208, engaging member 210 and insert member 212 should be manufactured out of metal or other materials having suitable strength, rigidity and corrosion resistance for the intended outdoor use on pickup truck 12 or be coated or treated with material, such as powder coating, to provide the desired corrosion resistance. Engaging member 210 and insert member 212 can be tubular or solid members. In one embodiment, platform member 208, engaging member 210 and insert member 212 are separate components that are suitably joined together, such as by welding or the like, to define a single, lower clamp assembly 204. Alternatively, the platform member 208, engaging member 210 and insert member 212 components can be integrally manufactured using processes well known to those skilled in the art of such manufacturing.

In a preferred embodiment, as shown in the figures, the upper end 224 of engaging member 210 is provided with a lower cushioning member 226 that is configured to abut the underside surface 214 of the upper edge 34 of bedrail 32 in manner that substantially prevents damage to underside surface 214. As known to those familiar with pickup trucks 12, the bedrail 32 thereon is made out of metal that is painted to match the rest of pickup truck 12. Lower cushioning member 226 is selected so as to prevent or at least substantially reduce the likelihood of damage thereto from the upper end 224 of engaging member 210. In a preferred embodiment, lower cushioning member 226 is a slightly compressible material, such as hard rubber or the like, that prevents damage to underside surface 214 while preventing upper end 224 of engaging member 210 from contacting underside surface 214. A variety of other materials may also be suitable for lower cushioning member 226.

Insert member 212 of lower clamp assembly 204 is configured with a means for engaging clamp 200 by connecting insert member 212 with upper clamp assembly 206 so as to secure truck rack 202 to bedrail 32 of pickup truck 12. In a preferred embodiment, the engaging means is a threaded aperture 228 at the upper end 230 of insert member 212, as best shown in FIG. 24, sized and configured to receive a like threaded screw 232. If insert member 212 is a solid component, then threaded aperture 228 can be disposed therein. If insert member 212 is a tubular component, then threaded aperture 228 can provided in a top portion of the tube. In a preferred embodiment, shown in the figures, insert member 212 is tubular and threaded aperture 228 is provided by a cap plate 234 attached to the upper end 230 of insert member 212, such as a weld nut that is welded onto or otherwise fixedly attached to the upper end 230 of insert member 212. As is apparent to those skilled in the art, various alternative mechanisms can be utilized to join lower clamp assembly 204 to upper clamp assembly 206 than the threaded aperture 228 and screw 232 described above and shown in the figures. As described below, any such mechanisms should be chosen to be able to securely, but removably, join lower 204 and upper 206 clamp assemblies to allow the user to easily and quickly install truck rack 202 onto pickup truck 12 or remove it therefrom as he or she may require or desire.

In the preferred configurations of clamp 200, upper clamp assembly 206 comprises a clamp member 236 sized and configured to engage base member 203 so as to securely hold it against upper edge 34 of bedrail 32 and a channel member 238 attached to clamp member 236 so as to define an insert channel 240 to receive insert member 212 therein. Preferably, insert channel 240 is sized and configured such that insert member 212 is slidably received therein to allow it to move at least somewhat freely relative to insert channel 240 in the direction of base member 203. The size of insert member 212 and insert channel 240 should be selected such that the two components cannot rotate relative to each other, or at least very limited rotation, and for only limited lateral movement to each other. Because insert member 212 is slidably received in insert channel 240, lower clamp assembly 204 may move horizontally relative to upper clamp assembly 206 so the user can easily adjust the location of clamp 200 in light of any obstruction that may be present under bedrail 32. As with the components of lower clamp assembly 204, clamp member 236 and channel member 238 of upper clamp assembly 206 should be manufactured out of metal or other materials having the suitable strength, rigidity and corrosion resistance for the intended outdoor use on pickup truck 12 or which may be coated or treated with another material, such as powder coating, to provide the desired corrosion resistance. In one embodiment, clamp member 236 and channel member 238 are separate components that are suitably joined together, such as by welding or the like, to define upper clamp assembly 206. Alternatively, the clamp member 236 and channel member 238 can be integrally manufactured using processes well known to those skilled in the art of such manufacturing.

As shown in the figures, clamp member 236 is an L-shaped component having a generally horizontal, outwardly projecting first section 242 and a generally vertical, downwardly projecting second section 244, with outwardly referring to the direction toward the outside of pickup truck 12 and away from rear cargo area 17 and downwardly referring to the direction toward the bed 16 of pickup truck 12. The horizontal first section 242 has an upper side 246 facing generally upward and a lower side 248 facing downward, which is toward the top surface of base member 203 when used to mount truck rack 202 to pickup truck 12. The vertical second section 244 has an outer side 250 and an inner side 252, with outer referring to the direction toward the outside of pickup truck 12 and inner referring to the direction towards the rear cargo area 17 of pickup truck 12.

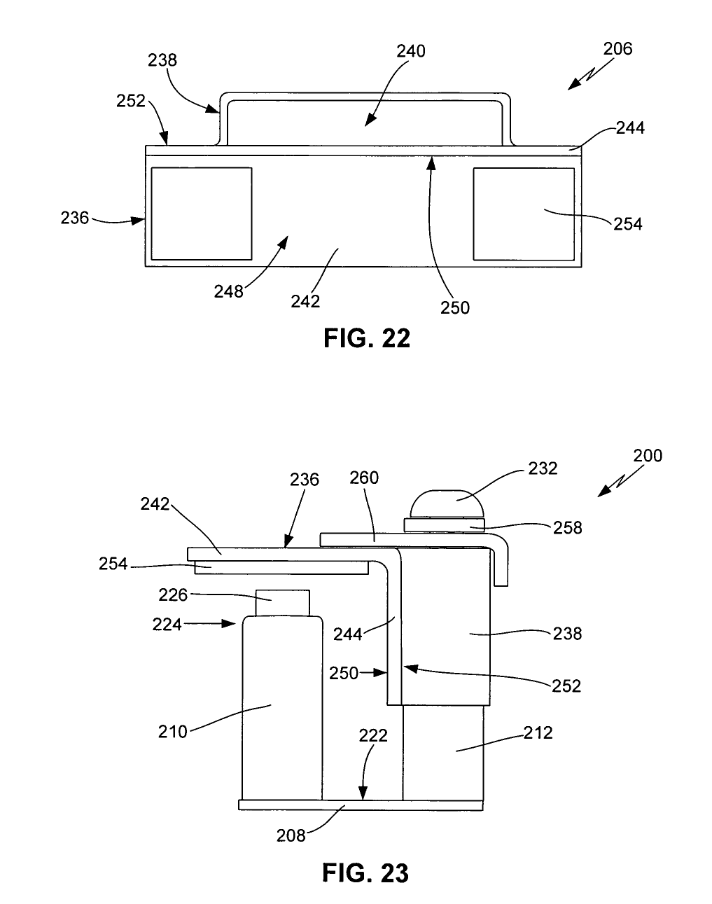

In a preferred embodiment, as shown in FIGS. 22 and 23, clamp member 236 has an upper cushioning member 254 on the lower side 248 of horizontal first section 242 that is configured to abut the top surface of base member 203 when clamping it against the top surface 216 of bedrail 32 in manner that substantially prevents damage to base member 203. Upper cushioning member 254 is selected so as to prevent or at least substantially reduce the likelihood of damage to the top surface of base member 203 of truck rack 202. As with lower cushioning member 226, in a preferred embodiment upper cushioning member 254 is a slightly compressible material, such as hard rubber or the like, that prevents damage to base member 203 while preventing lower side 248 of horizontal first section 242 from contacting base member 203. A variety of other materials may also be suitable for use as upper cushioning member 254.

In one configuration of clamp 200 of the present invention, shown in FIGS. 20 through 25, channel member 238 is a generally C-shaped component that is fixedly attached (i.e., by welding) to the inner side 252 of vertical second section 244 of clamp member 236, with insert channel 240 disposed between the inner side 252 and channel member 238, as best shown in FIGS. 21 and 22. As stated above, and best shown in FIGS. 20 and 25, insert member 212 is received in insert channel 240 defined by channel member 238. In this configuration, vertical second section 244 of clamp member 236 will be disposed between engaging member 210 and insert member 212, as best shown in FIGS. 22 and 25, with base member 203 disposed between upper cushioning member 254 on lower side 248 of the horizontal first section 242 and top surface 216 of bedrail 32. When in use, as shown in FIG. 25, lower cushioning member 226 at the upper end 224 of engaging member 210 will be against the underside 214 of bedrail 32. Depending on the strength of materials and connections used for clamp 200, an advantage of this embodiment is that the portion of insert channel 240 not occupied by insert member 212 can be utilized as a tie-down location. If the materials and/or connections are not so configured, then this configuration would likely be a disadvantage as persons may be tempted to utilize the available portion of insert channel 240 as a tie-down when it is neither intended nor designed for such use.

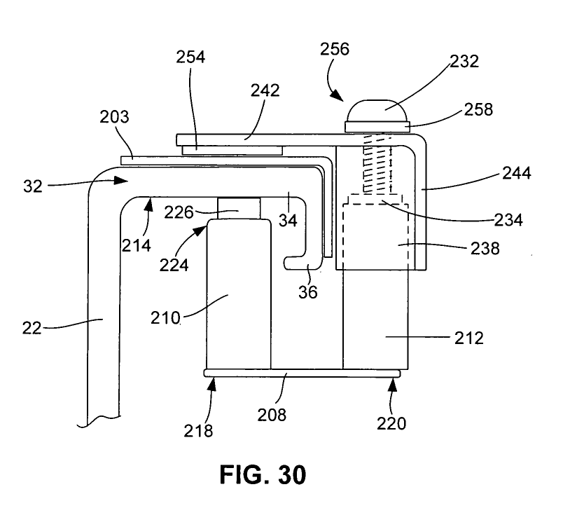

In an alternative configuration of clamp 200 of the present invention, shown in FIGS. 26 through 30, channel member 238 is a generally C-shaped component that is fixedly attached (i.e., by welding) to the outer side 250 of vertical second section 244 of clamp member 236, with insert channel 240 disposed between the outer side 250 and channel member 238, as best shown in FIGS. 27, 29 and 30. As stated above, and best shown in FIG. 30, insert member 212 is received in insert channel 240 defined by channel member 238. In this configuration, vertical second section 244 of clamp member 236 will be disposed inside (i.e., toward rear cargo area 20) of insert member 212, as best shown in FIGS. 26 and 30. When in use, as shown in FIG. 30, base member 203 of truck rack 202 will be disposed between upper cushioning member 254 on lower side 248 of the horizontal first section 242 and the top surface 216 of bedrail 32, with lower cushioning member 226 at the upper end 224 of engaging member 210 against the underside 214 of bedrail 32.

Clamp 200 also includes a clamping means 256 configured to clamp lower clamp assembly 204 and upper clamp assembly 206 together, at insert member 212, in order to secure base member 203 of truck rack 202 to bedrail 32 of pickup truck 12. The preferred clamping means 256 interconnects lower 204 and upper 206 clamp assemblies in a manner that securely, yet removably, clamps them together. In the embodiment of FIGS. 20 through 25, clamping means 256 comprises screw 232, washer 258 and the L-shaped clamp plate 260. As best shown in FIGS. 20, 23 and 25, screw 232 is received through an aperture (not shown) in clamp plate 260 to engage threaded aperture 228 at insert member 212. Washer 258 is disposed between the head of screw 232 and the top surface of clamp plate 260. When engaged in threaded aperture 228, screw 232 presses down on washer 258, which presses against clamp plate 260. Continued tightening of screw 232 in threaded aperture 228 will press clamp plate 260 against clamp member 236, thereby clamping base member 203 of truck rack 202 between the lower side 248 of horizontal first section 242, preferably with upper cushion member 254 thereon, and the top surface 216 of bedrail 32 by the action of the upper end 224 of engaging member 210 against the underside surface 214 of bedrail 32, preferably with lower cushioning member 226 therebetween.

In the embodiment of FIGS. 26 through 29, clamping means 256 merely comprises threaded screw 232 passing through aperture 262 in horizontal first section 232 and being received in threaded aperture 228 at the upper end 230 of insert member 212 (as above). When screw 232 is engaged in aperture 228, the head of screw 232 will press against the upper side 246 of horizontal first section 242, preferably with washer 258 disposed therebetween, to press clamp member 236 against base member 203. Further tightening of screw 232 will clamp base member 203 of truck rack 202 between the lower side 248 of horizontal first section 242, preferably with upper cushion member 254 thereon, and the top surface 216 bedrail 32 by the action of upper end 224 of engaging member 210 against the underside surface 214 of bedrail 32, preferably with lower cushioning member 226 therebetween. To facilitate insert member 212 being able to slide inside insert channel 240, as discussed above, it is preferred that aperture 262 have the slot or slot-like configuration shown in FIGS. 26, 28 and 29. In this manner, the user can partially engage screw 232 inside threaded aperture 228 to loosely connect lower 204 and upper 206 clamp assemblies together, slide one or both of these components as needed for the desired placement on base member 203 to avoid any obstructions and then tighten screw 232 to tightly engage clamp 200 so as to secure truck rack 202 to the bedrail 32 of pickup truck 12.

Although the foregoing description includes threaded screw 232 as the connecting mechanism to clamp lower 204 and upper 206 clamp assemblies together when securing base member 203 of truck rack 202 to the bedrail 32 of pickup truck 12, a variety of other connecting mechanisms can be utilized instead of screw 232, including various bolts and other connectors that are likely to suffice for clamp 200 of the present invention. In the preferred embodiment, any such connecting mechanism includes some type of security feature to at least make it difficult for unauthorized persons to disengage clamp 200 and remove truck rack 202 from pickup truck 12. In a preferred embodiment, with threaded screw 232 as the connecting mechanism, a security feature 264 is built into the drive opening 266 of the head of screw 232, as best shown in FIGS. 20 and 26. The security feature 264 can be as simple as a Torx® or similar type of less common drive opening 266, compared to slotted or Phillips heads, that at least reduces the likelihood that a potential thief will be able to easily remove truck rack 202 from pickup truck 12. For additional security, security feature 264 can be selected to require the use of a specially configured driver that is not readily available to the public or the use of a custom made, proprietary driver that is not available to the public at all. As known in the art, tamper resistant screws and bolts utilize specially designed drive openings 266, some of which may include one or more pins therein for additional security, that can only be engaged by a cooperatively configured bit which is supplied to the user when ordering the screws or bolts. Many of the designs for security feature 264 are proprietary, such that only the user is supplied with the driver bits that fit drive opening 215 of threaded screw 232. Use of such proprietary features can essentially make clamp 200 tamper proof. With a tamper resistant security feature incorporated into screw 232, the user can be relatively confident that the typical thief or other unauthorized persons will not be able to disengage clamp 200 to remove truck rack 202 from pickup truck 12.

In use, the user places base member 203 of truck rack 202 on the bedrail 32 of pickup truck 12 in the manner in which he or she would normally utilize truck rack 202. One or more clamps 200, typically a plurality, are then used to secure truck rack 202 to pickup truck 12. Lower clamp assembly 204 is placed in position with engaging member 210 inside of the lip 36 of bedrail 32 such that lower cushioning member 226 is placed against the underside surface 214 of bedrail 32 and insert member 212 disposed inward of bedrail 32 in the rear cargo area 17 of pickup truck 12. Upper clamp assembly 206 is placed in position by aligning insert channel 240, formed by channel member 238, with insert member 212 and clamp member 236 with the top side of base member 203. The upper clamp assembly 206 is then lowered onto lower clamp assembly 204 until clamp member 236 is in abutting relation with base member 203 and insert member 212 is disposed inside of insert channel 240. Alternatively, the user can position upper clamp assembly 206 first and then position lower clamp assembly 204 by aligning insert member 212 in insert channel 240 and engaging member 210 under bedrail 32. Lower 204 and upper 206 clamp assemblies are then slid into position, adjusting for any obstructions on or under bedrail 32, on base member 203.

Once in position, clamping means 254 is then utilized to clamp lower 204 and upper 206 clamp assemblies together, with base member 203 clamped against the top surface 216 of bedrail 32. In the embodiment of FIGS. 20 through 25, clamp plate 260 is utilized by inserting threaded screw 232 through clamp plate 260, with washer 258 disposed therebetween, to engage threaded aperture 228 at the upper end 224 of engaging member 210, which in the preferred embodiment is on cap plate 234. In the embodiment of FIGS. 26 through 30, the clamping is achieved by inserting threaded screw 232 through the aperture 262 (i.e., the slot) in clamp member 236 to engage threaded aperture 228. In either embodiment, further tightening of threaded screw 232 will draw lower 204 and upper 206 clamp assemblies together, thereby tightly clamping base member 203 between the lower side 248 of horizontal first section 242 of clamp member 236, preferably with upper cushion member 254 thereon, and the top surface 216 of bedrail 32 by the action of upper end 224 of engaging member 210 against the underside surface 214 of bedrail 32, preferably with lower cushioning member 226 therebetween. Removal of truck rack 202 is achieved by disengaging clamp 200, which is accomplished by loosening threaded screw 232, to remove lower 204 and upper 206 clamp assemblies from base member 203 and bedrail 32.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A clamp used in combination with a truck rack to secure a base member of said truck rack to a bedrail of a pickup truck, said clamp comprising:
a lower clamp assembly having a platform member with an engaging member and an insert member generally upwardly disposed thereon, said engaging member having an upper end configured to engage an underside surface of said bedrail, said insert member having means for engaging said clamp disposed at an upper end thereof;
an upper clamp assembly having a clamp member and a channel member attached to or integral with said clamp member, said clamp member having an outwardly projecting first section configured to engage said base member and a downwardly projecting second section, said channel member defining an insert channel sized and configured to receive said insert member therein; and
means interconnecting said engaging means and said upper clamp assembly for clamping said lower clamp assembly and said upper clamp assembly together with said base member secured between said clamp member and said bedrail and said upper end of said engaging member engaged against said underside of said bedrail.

2. The clamp according to claim 1, wherein said insert channel and said insert member are cooperatively sized and configured to substantially prevent rotation of said lower clamp assembly relative to said upper clamp assembly.

3. The clamp according to claim 1, wherein said channel member is attached to or integral with an inner side of said second section so as to define said insert channel.

4. The clamp according to claim 3, wherein said clamping means comprises a connector and a clamp plate, said connector configured to engage said clamp plate and be received by said engaging means at said upper end of said insert member, said clamp plate configured to press said clamp member against said base member so as to secure said truck rack on said bedrail.

5. The clamp according to claim 4, wherein said connector is a threaded screw and said engaging means is a cooperatively threaded aperture.

6. The clamp according to claim 5, wherein said threaded aperture is disposed in a cap plate at said upper end of said insert member.

7. The clamp according to claim 1, wherein said channel member is attached to or integral with an outer side of said second section so as to define said insert channel.

8. The clamp according to claim 7, wherein said clamping means comprises a connector disposed through an aperture in said clamp member, said connector configured to engage said clamp member and be received by said engaging means at said upper end of said insert member to press said clamp member against said base member so as to secure said truck rack on said bedrail.

9. The clamp according to claim 8, wherein said connector is a threaded screw and said engaging means is a cooperatively threaded aperture.

10. The clamp according to claim 9, wherein said threaded aperture is disposed in a cap plate at said upper end of said insert member.

11. The clamp according to claim 1 further comprising a lower cushioning member at said upper end of said engaging member, said lower cushioning member configured to engage said underside surface of said bedrail.

12. The clamp according to claim 11 further comprising an upper cushioning member at an upper side of said first section of said clamp member, said upper cushioning member configured to engage said base member.

13. A clamp used in combination with a truck rack to secure a base member of said truck rack to a bedrail of a pickup truck, said clamp comprising:
a lower clamp assembly having a platform member with an engaging member and a spaced apart insert member generally upwardly disposed thereon, said engaging member having an upper end configured to engage an underside surface of said bedrail, said insert member having an aperture at an upper end thereof;
an upper clamp assembly having a clamp member and a channel member, said clamp member having an outwardly projecting first section configured to engage said base member and a downwardly projecting second section, said channel member attached to or integral with said second section so as to define an insert channel sized and configured to slidably receive said insert member therein; and
a connector configured to engage said aperture so as to clamp said lower clamp assembly and said upper clamp assembly together with said base member secured between said clamp member and said bedrail and said upper end of said engaging member engaged against said underside of said bedrail.

14. The clamp according to claim 13 further comprising a lower cushioning member at said upper end of said engaging member, said lower cushioning member configured to engage said underside surface of said bedrail.

15. The clamp according to claim 14 further comprising an upper cushioning member at an upper side of said first section of said clamp member, said upper cushioning member configured to engage said base member.

16. The clamp according to claim 13 further comprising a clamp plate, said channel member attached to or integral with an inner side of said second section of said clamp member so as to define said insert channel, said connector configured to engage said clamp plate and press said clamp member against said base member so as to secure said truck rack on said bedrail.

17. The clamp according to claim 13, wherein said channel member is attached to or integral with an inner side of said second section of said clamp member, said connector configured to engage said clamp member and press said clamp member against said base member so as to secure said truck rack on said bedrail.

18. The clamp according to claim 13, wherein said insert channel and said insert member are cooperatively sized and configured to substantially prevent rotation of said lower clamp assembly relative to said upper clamp assembly and allow limited lateral movement of said lower clamp assembly relative to said upper clamp assembly.

19. A clamp used in combination with a truck rack to secure a base member of said truck rack to a bedrail of a pickup truck, said clamp comprising:
a lower clamp assembly having a platform member with an engaging member and a spaced apart insert member generally upwardly disposed thereon, said engaging member having an upper end having a lower cushioning member configured to engage an underside surface of said bedrail, said insert member having a threaded aperture at an upper end thereof;
an upper clamp assembly having a clamp member and a channel member, said clamp member having an outwardly projecting first section and a downwardly projecting second section, said first section having an upper cushioning member on a lower side configured to engage said base member, said channel member attached to or integral with said second section so as to define an insert channel sized and configured to slidably receive said insert member therein; and
a connector configured to engage said threaded aperture so as to clamp said lower clamp assembly and said upper clamp assembly together with said base member secured between said clamp member and said bedrail and said upper end of said engaging member engaged against said underside of said bedrail.

20. The clamp according to claim 19 further comprising a clamp plate, said channel member attached to or integral with an inner side of said second section of said clamp member so as to define said insert channel, said connector configured to engage said clamp plate and press said clamp member against said base member so as to secure said truck rack on said bedrail.

21. The clamp according to claim 19, wherein said channel member is attached to or integral with an inner side of said second section of said clamp member, said connector configured to engage said clamp member and press said clamp member against said base member so as to secure said truck rack on said bedrail.
